(19) United States
(12) Patent Application Publication
(10) Pub. No.: US 2009/0174623 A1
(43) Pub. Date: Jul. 9, 2009

(54) COMPACT BROADBAND ANTENNA

(75) Inventors: Ludovic SCHREIDER, Muret (FR); Michel Jousset, Ploumaguer (FR); Gwenaelle Guillory, Brest (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/255,858

(22) Filed: Oct. 22, 2008

(30) Foreign Application Priority Data
Oct. 23, 2007 (FR) 0707416

(51) Int. Cl. H01Q 1/38; H01Q 1/36

(52) U.S. Cl. 343/895; 343/700 MS; 340/539.13

(57) ABSTRACT

The invention relates to an antenna (ANT) comprising a radiating element (ELR) mounted above a substantially flat reflector. The radiating element (ELR) is of the broadband type and substantially flat. The reflector (SHI) has a metal periodic network (RS) of regular patterns in two dimensions, and a ground plane (PM) formed by the bottom face of the surface of the high impedance type. Each pattern of the periodic network (RS) is respectively connected to the ground plane (PM). The antenna having a thickness of the order of 1/13^{th} of the wavelength at the minimum frequency of the frequency band.

### RELATED APPLICATIONS

The present application is based on, and claims priority from, French Application Number 0707416, filed Oct. 23, 2007, the disclosure of which is hereby incorporated by reference herein in its entirety.

### TECHNICAL FIELD

The invention relates to antennas, in particular the antennas called broadband, incorporated into satellite positioning systems.

### BACKGROUND OF THE INVENTION

In a satellite positioning system, the location of an object, that is to say the determination of its space coordinates x, y, z, is carried out in a known manner by the determination of the propagation time T of a particular microwave between each satellite and the object, the propagation time making it possible to determine the distance from the object to the satellite. Knowing the distance relative to at least four satellites makes it possible then to determine its position in an absolute space coordinate.

Currently, the broadband antennas used within positioning systems are in particular antennas (for example the “spiral” antennas) so bulky that they cannot notably be incorporated into the latest generations of GPS systems.

Furthermore, these antennas are capable of being incompatible with other systems, notably because of their lack of compactness.

The object of the invention is notably to provide a solution to this problem.

One object of the invention is to propose a compact antenna that is able notably to be incorporated into satellite positioning systems.

Another object of the invention is to propose a use of the antenna according to the invention within a satellite positioning system.

### SUMMARY OF THE INVENTION

According to one aspect of the invention, an antenna is proposed comprising a radiating element mounted above a substantially flat reflector.

According to a general feature of the invention, the radiating element is of the broadband type and substantially flat and the reflector comprises:

a metal periodic network of regular patterns in two dimensions, and

a ground plane formed by the bottom face of the surface of the high impedance type, each pattern of the periodic network being respectively connected to the ground plane, said antenna having a thickness of the order of 1/13^{th} of the wavelength at the minimum frequency of the frequency band.

In other words, the antenna is extremely compact thanks notably to the structure used to form its reflector.

This compact structure allows the antenna to be incorporated into satellite positioning systems, notably the latest generation systems. Furthermore, the antenna retains a high output while having a reduced manufacturing cost because of the simplicity of its production.

Specifically, the inventors have noted that the combination of a radiating element of the broadband type with a high impedance surface that is extremely thin (substantially equal to the thickness of the antenna since the thickness of the radiating element is negligible), made it possible to obtain an antenna covering a particularly worthwhile frequency band, in particular for use within satellite positioning systems.

Furthermore, the antenna has a small space requirement and a high output. This performance was then impossible with existing antennas, unless extremely bulky antennas were designed. This lack of compactness is not compatible with all the applications.

For example, the radiating element may be of the spiral type.

More precisely, said radiating element may be an Archimedean spiral with 2 or 4 radiating strands, made on a dielectric support.

According to one embodiment, the antenna is capable of operating for signals whose frequency is between 1.15 GHz and 1.595 GHz.

According to one embodiment, the patterns are separated from one another by a space of the order of 3 mm.

According to one embodiment, the diameter of a circle that can be inscribed inside the reflector is of the order of 155 mm.

According to one embodiment, the outer diameter of the radiating element is of the order of 106 mm.

According to one embodiment, the radiating element is printed on an insulating foam.

According to one embodiment, the patterns of the network are square in shape.

According to one embodiment, the distance between the reflector and the radiating element is of the order of 1/50 of the wavelength corresponding to the bottom frequency of the frequency band of operation of the antenna.

According to another aspect, a use of an antenna as described hereinabove is proposed within a satellite positioning system.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents an embodiment of an antenna according to the invention;

FIG. 2 represents a view in section of an embodiment of an antenna according to the invention; and

FIG. 3 illustrates an exemplary embodiment of an antenna according to the invention.

### DETAILED DESCRIPTION OF THE INVENTION

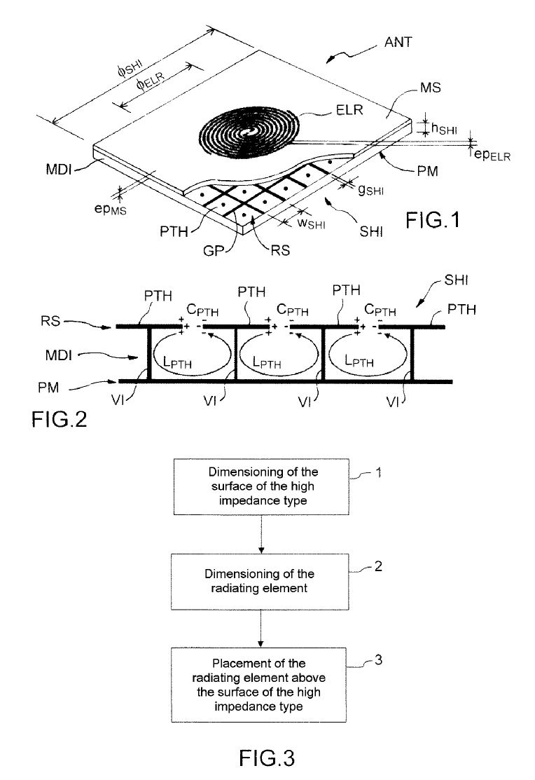

Reference is made to FIG. 1, which represents an antenna with the reference ANT.

This antenna ANT comprises a radiating element ELR placed above a reflector routinely called a surface of the high impedance type SHI (called “Sievenpiper”) by those skilled in the art. In this example, the radiating element ELR is of the “broadband” type.

The concept of “broadband” may be defined in various ways.

For example, it is considered that the radiating element is of the “broadband” type if it can transmit signals belonging to a frequency band [Fₘᵢₙ, Fₘₐₓ], such that the frequency bandwidth L_{BF} is greater than a chosen percentage X:

$${L}_{BF} = \frac{{F}_{max} - {F}_{min}}{{F}_{0}} \geq X \% , where {F}_{0} = \frac{{F}_{min} + {F}_{max}}{2} .$$

Preferably, this percentage X may be equal to 30%, this value being able to characterize the “broadband” antennas for certain uses.

It is also possible to define the concept of “broadband” by the fact that the transmitted signals belong to a frequency band [Fₘᵢₙ, Fₘₐₓ,], such that Fₘₐₓ=k*Fₘᵢₙ, where, for example, k>8. Conventionally, the aforementioned frequency band even has a bandwidth greater than the decade (k>10).

The radiating element ELR may be of the spiral type. In this example in particular, the radiating element is an Archimedean spiral with 2 radiating strands. But the antenna ANT could be produced with the aid of an Archimedean spiral with 4 radiating strands or else with the aid of an equiangular spiral.

It is well known to those skilled in the art that the two radiating strands are supplied in phase opposition with the aid of a suitable supply, not shown in FIG. 1, for simplification purposes. Preferably, a “balun” (for “balanced to unbalanced”) supply will be used. This type of supply makes it possible to make the connection between a symmetrical transmission line (in this instance the radiating strands) and an asymmetric transmission line (for example a coaxial cable or a line printed on a ground plane).

The radiating element ELR is, for example, printed on a dielectric material, in this instance an insulating foam MS.

The radiating element ELR may also be of the butterfly type, in the shape of an “8”.

The surface of the high impedance type SHI illustrated in FIG. 1 is again called a “Sievenpiper” surface. It is formed of a periodic network of patterns RS, also called metal patches, in two dimensions. In FIG. 1, the pattern PTH of the network RS has a square shape, but it may have another shape, hexagonal or triangular for example. The squares are separated from one another by a thin space GP.

Each pattern PTH is linked to a ground plane PM formed by the bottom face of the surface of the high impedance type SHI. The connection between the network RS and the ground plane PM is made with the aid of vias described in greater detail below.

The patterns PTH are for example printed on an insulating support referenced MDI in this example.

The surface of the high impedance type as shown in FIG. 1 has the advantage of preventing the propagation of surface currents, under certain conditions of use. Within conventional antennas, the proximity of the radiating element and of the metal reflector causes the generation of these surface currents opposing the current traveling in the radiating element. The consequences of the appearance of these surface currents are a reduction in the bandwidth of the antenna, a low radiation efficiency and a degradation of the radiation patterns, that is to say a reduction in the power radiated by the antenna per unit of solid angle in the various directions of space.

The patterns PTH are of very small dimensions relative to the wavelength of the signals transmitted by the antenna ANT.

These small dimensions reveal capacitive elements C_{PTH} and inductive elements L_{PTH} as shown in FIG. 2. This figure represents a view in section of the surface of the high impedance type SHI. Vias VI connect the network RS and the ground plane MS.

Therefore, the surface of the high impedance type SHI may be modeled by a parallel circuit LC. The capacitive element C (capacitance equivalent to the value of all the capacitive elements C_{PTH}) of the circuit is associated with the distance apart of the metal patches PTH while the inductive effect L (inductive effect equivalent to the value of all the inductive elements L_{PTH}) is introduced by the presence of the vias VI connecting the patches PTH to the ground plane PM.

Each arrow made between the patches PTH and the ground plane PM symbolizes the circulation of a current.

By adopting this simplified representation, the impedance of the surface of the high impedance type SHI is equivalent to that of a resonant circuit:

$$Z = \frac{{Z}_{L} {Z}_{C}}{{Z}_{L} + {Z}_{C}} = \frac{j L ω}{1 - LC {ω}^{2}} , where$$

Z is the impedance of the surface of the high impedance type;
Z_{C} is the value of the capacitive element of the surface of the high impedance type;
Z_{L} is the value of the inductive effect of the surface of the high impedance type.

The value of the inductive effect L is greater the longer the vias VI, while the value of the capacitive element C is greater the smaller the distance between the patches PTH. For production reasons, the distance between the patches PTH cannot reach very small dimensions and for reasons of integration of the surface of the high impedance type SHI, the height of the vias cannot be too high. Examples of dimensions will be given below.

The value of the capacitance of the surface of the high impedance type SHI is given by the following equation:

$$C = \frac{{w}_{SHI} ( {ɛ}_{1} + {ɛ}_{2} )}{π} {cosh}^{- 1} ( \frac{2 {w}_{SHI}}{{g}_{SHI}} ) , where$$

C corresponds to the value of the capacitance of the surface of the high impedance type SHI in Farads per unit of surface area;
w_{SHI} corresponds to the width of each patch of the surface of the high impedance type;
ε₁ corresponds to the permittivity of the dielectric medium referenced MDI;
ε₂ corresponds to the permittivity of the dielectric medium referenced MS; and
g_{SHI} corresponds to the width of the space existing between each patch.

The value of the equivalent inductance of the surface of the high impedance type is given by:

L=μ₀μᵣh, where
L corresponds to the value of the equivalent inductance of the surface of the high impedance type in Henrys per unit of surface area;
μ₀ corresponds to the permeability of the vacuum (in H/unit of surface area), and
μᵣ corresponds to the relative permeability (without dimension) of the dielectric material referenced MDI.

The resonance frequency f₀ of the surface of the high impedance type is given by:

$${f}_{0} = \frac{1}{2 π \sqrt{LC}} .$$

The surfaces of the high impedance type have as a property, from the electromagnetic point of view, to authorize the propagation of magnetic waves on their surface only for certain frequencies. In other words, the surfaces of the high impedance type behave like uniform surfaces that possess a very high impedance.

Conversely, the propagation of the surface waves is not allowed for a frequency band called a “forbidden band”. This forbidden band is centered on the resonance frequency f₀ of the surface of the high impedance type. In other words, the incident waves on this type of surface are reflected with zero phase shift.

The frequency band of the signals for which the antenna ANT operates corresponds to the forbidden band of the surface of the high impedance type.

More precisely, the forbidden band is defined by the phase φ of the coefficient of reflection of the high impedance surface, the coefficient of reflection being written in the form |ρ|e^{jφ}. The phase φ of the coefficient of reflection of a high impedance surface varies between −90° and +90°.

Therefore, the reflector made with the aid of a surface of the high impedance type does not disrupt the signals transmitted by the antenna.

As an example, all the electromagnetic properties of the surfaces of the high impedance type called Sievenpiper are described in the article “D. Sievenpiper, L. Zhang, R. F. J. Broas, N. G. Alexopolous, and E. Yablonovitch, “High-impedance electromagnetic surfaces with a forbidden frequency band”, IEEE Transactions on Microwave Theory and Techniques, Vol. 47, No. 11, pp. 2059-2074, November 1999”.

FIG. 3 illustrates an exemplary embodiment of an antenna according to the invention, with the various elements dimensioned to suit an antenna operating in the frequency band [1.15 GHz, 1.595 GHz].

During a first step 1, the surface of the high impedance type is dimensioned. This dimensioning is carried out so that the resonance frequency of the surface of the high impedance type is situated in the middle of the operating frequency of the antenna (forbidden band from the point of view of the surface of the high impedance type). For example, if the antenna is incorporated into a satellite positioning system (such as GPS or GALILEO), the resonance frequency is situated between the values 1.15 GHz and 1.595 GHz.

An example of dimensions of the surface of the high impedance type is given below.

Then, the radiating element is dimensioned 2 so that the antenna can effectively operate in the chosen frequency range.

An example of dimensions of the radiating element is given below.

Finally, the radiating element is placed 3 above the surface of the high impedance type. For example, the radiating element is placed at a distance equal to 1/50 of the wavelength corresponding to the bottom frequency of the operating frequency band of the antenna.

In this way, an antenna well suited to the chosen application is obtained, namely a broadband operation that has a high output while being compact.

The radiation efficiency of the antenna is therefore optimal despite a relatively small thickness of the order of 1/13 of the wavelength at the minimum frequency of the chosen frequency band. Therefore, the thickness of the high impedance surface SHI can be assimilated to the total height of the antenna, given that the thickness of the antenna and of the foam MS is negligible ( 1/50<< 1/13) relative to that of said high impedance surface.

Therefore, to obtain the same radiation efficiency with a metal reflector, the radiating element should be placed at a distance corresponding to ¼ of the wavelength. This distance would make it impossible to integrate the corresponding antenna within a satellite positioning system, and would limit its operation to a narrow frequency band.

As an example, the dimensions of the various elements constituting the antenna for a broadband operation may be (see FIG. 1):
for the surface of the high impedance type: w_{SHI}=22 mm, g_{SHI}=3 mm, φ_{SHI}=155 mm (φ_{SHI} being the diameter of a circle that can be inscribed in the surface of the high impedance type), h_{SHI}=14 mm and ε_{SHI}=2.2;
for the radiating element: φ_{ELR}=106 mm (φ_{ELR} being the outer diameter of the radiating element), ep_{ELR}=0.127 mm, ε_{ELT}=2.94; and
for the dielectric material on which the radiating element is made: ep_{MS}=5 mm, ε₁=1.07.

Naturally, these examples of dimensions are given as an indication. They may vary around the values indicated, depending on the application for which the system incorporating the antenna is intended.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. An antenna comprising a radiating element mounted above a substantially flat reflector, characterized in that the radiating element is of the broadband type and substantially flat, and in that the reflector comprises:
a metal periodic network of regular patterns in two dimensions, and
a ground plane formed by the bottom face of the surface of the high impedance type, each pattern of the periodic network being respectively connected to the ground plane, said antenna having a thickness of the order of 1/13^{th} of the wavelength at the minimum frequency of the frequency band.

2. The antenna as claimed in claim 1, wherein the radiating element is of the spiral type.

3. The antenna as claimed in claim 2, wherein said radiating element is an Archimedean spiral with 2 or 4 radiating strands made on a dielectric support.

4. The antenna as claimed in claim 3, capable of operating for signals whose frequency is between 1.15 GHz and 1.595 GHz.

5. The antenna as claimed in claim 4, the patterns being separated from one another by a space of the order of 3 mm.

6. The antenna as claimed in claim 5, wherein the diameter of a circle that can be inscribed inside the reflector is of the order of 155 mm.

7. The antenna as claimed in claim 6, wherein the outer diameter of the radiating element is of the order of 106 mm.

8. The antenna as claimed in claim 7, wherein the radiating element is printed on an insulating foam.

9. The antenna as claimed in claim 8, wherein the patterns of the network are square in shape.

10. The antenna as claimed claim 9, wherein the distance between the reflector and the radiating element is of the order of 1/50 of the wavelength corresponding to the bottom frequency of the frequency band of operation of the antenna.

11. The use of an antenna as claimed in claim 10, within a satellite positioning system.
